(19) United States
(12) Patent Application Publication
(10) Pub. No.: US 2008/0314601 A1
(43) Pub. Date: Dec. 25, 2008

(54) Helicopter water bucket improvements

(76) Inventor: Robert Cafferata, Richmond (CA)

Correspondence Address: Robert Cafferata, Unit 306 - 7251 Langton Road, Richmond, BC, V7C 4R6, CA

(21) Appl. No.: 11/821,490

(22) Filed: Jun. 22, 2007

(51) Int. Cl. A62C 3/00

(52) U.S. Cl. 169/34

(57) ABSTRACT

A collapsible wild fire fighting water bucket made from pliable material and suspended from an aircraft to be lowered into an open body of water for filling. A weighted Rim Opening Device holds the bucket top open for filling and facilitates a tipping over action during filling. The buckets open top being free of any centrally located supports. The bucket is equipped with a tubular extension which forms a discharge port for dumping water. The tubular extension being releasably supported under water inside the bucket under tension. Purse lines running through openings in the tubular extension and resilient sealing lips bring sealing lips into abutment sealing the discharge port of the tubular extension.

Suspension lines suspend the bucket from the aircraft and a releasable support, releasably supports the free end of the tubular extension within the bucket body extending upwardly from the openings to close the discharge port. The releasable support cooperates with the openings to allow the tubular extension to be rapidly lowered so as to extend downwardly from the bottom to open the discharge port for dumping the water. The purse lines cooperate with the releasable support to lift and lower the tubular extension. The buckets also are equipped with emergency extractor Jump Seats, secured to the inside wall of the bucket to be used for dire straits emergency extraction of wild fire ground crews trapped by fire storm.

### REFERENCES CITED

US Patent Documents

| | | | |
|---|---|---|---|
| 3093295 | June 1963 | Kugler | 383/75 |
| 3572441 | March 1971 | Nodegi | 169/53 |
| 366121 | May 1972 | Powers | 169/53 |
| 3716868 | January 1973 | Chadwick | 169/53 |
| 4474245 | October 1984 | Arney | 169/53 |
| | | | 169/34 |
| | | | 169/35 |
| 4240507 | December 1980 | Hokkanen | 169/53 |
| 4576237 | March 1986 | Arney | 169/53 |
| 4671472 | June 1987 | Hawkshaw | 244/136 |
| 5560429 | October 1996 | Needham | 169/53 |
| 5692868 | December 1997 | Riemersma | 294/68 |
| 5829809 | November 1998 | Arney et al. | 294/68 |
| 61929809 | February 2001 | Brooke | 169/53 |

Canadian Patents

| | | | |
|---|---|---|---|
| CA 1232889 | July 1983 | Arney | 244/104 |
| CA 1231311 | August 1984 | Arney | 190/1 |
| CA 2124166 | May 1994 | Needham | 169/53 |
| CA 2297296 | January 2001 | Brooke | 169/53 |
| SEI Industries Ltd. | April 1999 | Page 17 - FIG. 14, 15 | |
| Bucket Manual | | Page 41, Page 45 | |

### BACKGROUND OF THE INVENTION

1. Field of the Invention

The invention relates to a firefighting bucket assembly to be suspended from an aircraft and preferably filled from an open body of water, ie. from a lake.

2. Prior Art

From U.S. Pat. No. 3,661,211 Powers is known for a collapsible fire fighting bucket, which could be filled by immersion in a lake.

The bucket framework which supported its pliable side walls had four normally upright but collapsible supports connecting rigid upper peripheral frame member to a rigid circular bottom. The water level being controlled by spill ports to adjust overall bucket weight to match the lifting capabilities of the aircraft. Two hydraulically operated doors released the water. When collapsed the bucket was bulky, difficult to transport, additionally the water release mechanism was heavy and expensive to manufacture. From U.S. Pat. No. 3,572,441 issued to Nodegi describes a flexible bag having a snout like flexible extension which when pulled into the bag from a line entering the top of the bag had to keep the free end of the tubular snout like extension above water. When the line was released the weight of the water inverted the tubular extension thereby releasing the water. When empty the connecting line was made to pull the extension back into the bag where a latching system held it in place.

The disadvantages of this system were the discharge port had to be held above the water level of the bag, the length of the extension caused a twisting action which could prevent dumping. In order to refill the bag it had to be transported to a filling station which resulted in loss of time increasing operational costs accordingly.

The bucket assembly described in Arney's CA 1232889 and U.S. Pat. No. 4,474,245 revolutionized aerial firefighting operations. Its simple design, lightweight, its collapsability for storage and transportation, operational supperiority over prior art, has redefined aerial firefighting technologies.

Arney's invention has two bucket adjusting means which co-operate with the side wall to adjustably vary the circumference of the bucket. Firstly; bending battens inserted in pockets vertically arranged around the bucket and dimensioned apart peripherally allow the side walls to bulge outwardly to increase capacity in direct relationship to the upward force applied, allowing the operator to match the lifting capability of the helicopter to the overall weight of the bucket. This feature helped eliminate the need for spill ports utilized by Powers in US Pat 3661,211 for that purpose

Secondly; independently from varing the pulling force as described above to limit bucket capacity Arney introduced an adjustable circumferential tension link. A cinch belt slidably received in belt loops around the buckets circumference can be adjusted to limit its capacity. The operator simply adjusts bucket capacity to lifting capability of the helicopter by adjusting the cinch belt in the lockable cinch belt adjuster.

The bucket rim was stiffened by overlapping battens strung through belt loops placed around and adjacent to bucket rim. Operationally this proved to be a time consuming awkward task, begging for improvement.

Arney's improvement on Nodegi U.S. Pat. No. 3,572,441 Patent involved sealing the discharge ports of the tubular extension when it's underwater, upright and under tension from its supporting means. Third flexible tension links, purse lines, alternately affixed through opposing resilient sealing lips closed the discharge port when under tension from the supporting tension link which is adjustably connected to the electro-mechanical control head connector which the operator utilizes to open & close the discharge port for filling and releasing water.

Needhams CA 2,124,166 and U.S. Pat. No. 55,670,429 patents improved the sealing lip abutment to reduce leakage caused by purse line abrasion placing the grommets in the tubular extension adjacent to the resilient sealing lips which eliminated having the purse lines running through the resilient sealing lips, thereby eliminating abrasion to the rather soft resilient sealing lip material.

This abrasion increased the tubular extension maintenance factor. The entire tubular extension required removal from the bucket for this servicing, which in many cases required returning the bucket to the manufacturer, transportation and downtime causing additional expense.

Despite Needham's improvements to the sealing lip design further design changes could reduce water leakage through the sealing lips. One problem exists with a kink appearing in the distal end of the tubular extension when it's under tension from the second flexible link which holds the tubular extension in the underwater upright position. The kinked shape in some cases can be severe, especially if the third flexible tension links are poorly adjusted. The kinking occurs as a result of the third flexible tension links ie, the purse lines being gathered together at the terminal end of the second flexible tension link ie, in the ring to which the purse lines are adjustably connected. The purse lines fan out radially downward from the single collection point ie, the ring, to the dimensionally arranged openings in the tubular extension extending to the essentially horizontal distal ends of the tubular extension.

The outermost purse lines under tension are sharply angled upward from the outer ends of the tubular extension toward the collector ring. This generates an inwardly movement of the outermost ends of the tubular extension when under tension from the second flexible tension link, which causes the fold or kink to occur which can effect the proper alignment and abuttment of the sealing lips with potential water loss associated. Larger buckets with wider tubular extensions are more prone to this problem because the angle of the purse lines is increased accordingly at their distal ends. As the purse lines pass downwardly from the second flexible tension link ring through the hub the outermost lines become diverted by the hub increasing the angle and further developing a pronounced kink. The reader is directed to the SEI Industries Ltd. copyrighted Owners Manual produced in April 1999 which pictures both of these problems.

One objective of the Rim Opening Device Invention is to reduce purse line abrasion on the sealing lips as they pass through the sealing lips similar to Arney's CA 1232889 and U.S. Pat. No. 4474245 submissions.

Another objective of the Rim Opening Device Invention was to eliminate the central hub which diverts and increases the purse line angle to the collector ring which exacerbates the kink and potential water loss through misaligned sealing lips.

Needham's tubular extension was made narrower at its terminal end than at its base to assist the tubular extensions return to its' upright position within the bucket. This change was limited to the smaller buckets only, due to the stiffness associated with smaller tubular extensions.

Larger diameter tubular extensions utilized on both medium and large buckets being more flexible were not affected, no change in the straight diameter design were required.

Another objective of the Rim Opening Device Invention is to make the tubular extensions more flexible to assist the tubular extension's return to its upright position within the bucket.

The aerial firefighting condition can aggressively subject the aerial firefighting bucket to physical damage. Ideally the bucket is allowed to submerge in an open body of water for filling purposes.

The operators often find it necessary to scrounge water from any available source ie, shallow ponds, creekbeds, rivers, etc. where all manner of conditions and debris can inflict damage to the bucket. A typical example would be dragging the bucket along a shallow creekbed or river filled with sharp rocks, gravel, mud, uprooted trees, etc. This subjects the buckets upper rim, side walls & bottom of the bucket to aggressive abrasion, which can cause ripping and tearing of the pliable material. It has been found that both debris and bucket suspension lines can get entangled and hung up on the centrally located hub and spoke rim opening device, resulting in lost time to land and re-configure lines and remove debris.

Other damage can occur in operational conditions such as impact, hard landings, hangups, emergency release of entire bucket when snagged or hung up.

It's just the nature of the business, however; design changes can mitigate physical damage to the aerial firefighting bucket.

Another objective of the Rim Opening Device Invention is to totally eliminate the hub and spokes or any structural members centrally located within the bucket, producing a collapsible bucket with a centrally open orifice.

The central hub and spoke rim opening device which Needham describes in CA 2124166 and U.S. Pat. No. 5,560,429 can prove to be difficult to deploy on the larger buckets which are constructed of heavier, stiffer materials than their smaller counterparts. The operator must muscle the hub & spoke rim opener into the overcenter position by fighting the stiff action and tightfitting device past center. It is sometimes necessary to utilize a lever to pop it over center, when it does so it either quickly jumps out at you or plunges inward, care must be taken in its deployment.

Needham also describes in claim 7 and lines 38 et., of column 4 of the Detailed Description in the above noted patents, a Rim Opening Device. It comprises of a hollow hub centrally located and having a plurality of spokes which have their inner ends hinged from the central hub. They extend radially with their outer ends hinged adjacent the bucket rim and cooperating with the side wall to open and close the bucket somewhat like an umbrella. The spokes being dimensioned such as to allow an overcentering of the hub and spokes slightly above the bucket rim elevation. This device marked a significant improvement over Arney's upper rim stiffening batten system as described in his CA 1232889 and U.S. Pat. No. 4,474,245 patents. However the umbrella like hub and spoke device is not without shortcomings.

Another objective of our Rim Opening Device Invention is to improve not only the deployment and collapsibility of the bucket but also operational safety while undertaking these activities in the field of operations.

Needham's bucket mouth held open by a hub and spoke apparatus was a great improvement over the prior art of the time. The distal ends of the spokes dimensionally connected around the rim provide rim support at the connection point which assists the immersion process. However, Needham's bucket has some tendency to float on the surface prior to immersion. There are two reasons for this phenomenon, firstly; the rim is made of quite flexible material and is not supported between the distal ends of the spokes to which it is connected, the flexible material is pushed upward upon laying down rather than quickly penetrating the surface, secondly; both Arney's and Needham's tipping weight systems connects weight shot bags or blocks to the shell of the bucket, somewhat below the rim, their weight distending the shell curvature when laid horizontally on the water. The distended shape forms a shallow hull which promotes floating not submersion slowing the filling process.

Another objective of our Rim Opening Device Invention was to truly achieve rapid submersion and filling, overcoming the above noted phenomenon by re-enforcing the rim, buttressing the rim circumferentially and by concentrating the tipping weights right at the rim not below it to achieve this objective.

A significant problem exists with Needhams CA 2,124,166 and U.S. Pat. No. 55,670,429 umbrella like bucket opening device is water loss out of the bucket during flight. Water loss being caused by a constant undesirable flexing of the bucket shell, a repetitive in and out action generated at the bucket's rim, but transferred throughout the entire bucket disturbing the contained water, and transmitting a harmonic vibration that can sometimes be felt all the way up to the helicopter.

Both the deployment cable that lifts the hub into the operational position and the bucket's suspension lines are under tension from the electro-mechanical control head connector to which they are dually attached. Now the overcentered centrally located hub radially connects the distal ends of the inclined spokes to the perimeter of the bucket shell.

As the prior art bucket moves at speed through the air it is buffeted about and disturbed in flight which causes a back and forth transfer of weight on and off the hub. As the tension on the hub abruptly drops so does the hub, only to be violently jerked back up again; up-down, up-down, over and over again generating an undulating pulsing action.

As the centrally located hub radially connects the spokes to the bucket rim the up and down movement described above causes the perimeter of the bucket rim to move slightly in and out, over and over again. Over time the rotatably connected spokes, brackets and hub connections become worn; holes, elongated, oscillated especially when hollow spokes are utilized, the worn parts co-operate to increase the intensity of the undesirable pulsing and harmonic vibrations.

Additionally, because the overcentered hub and upper portions of the inclined spokes are positioned above the bucket's rim they collide with high speed air during flight redirecting or defecting the turbulent air into the mouth of the bucket colliding with the agitated water (provoked by the pulsing, undulating, harmonic vibrations) to generate a spray of water out of the bucket, much like a gale force wind will blow the tops of whitecaps at sea. The design and positioning of the umbrella like device propagates water loss out of the bucket during flight.

Other objectives of our Rim Opening Device Invention is to create a bucket with superior air flow characteristics which would reduce water loss, eliminate vibrations, pulsing and surging, in general produce superior inflight characteristics which help reduce pilot fatigue.

Another objective of this invention was to provide a simple, inexpensive secondary discharge tube which could be utilized by ground crews to manually fill back packs, water storage bags, small tanks, from a bucket slung from under the helicopter. Currently, there are two methods which this writer is familiar with.
1. an expensive pump system operated by ground crews.
2. a rotatable stiff tube corrected to a through hull rotatable bulkhead fitting the tube extending above the bucket rim when in the upright position, and connected thereto by a quick connector.

Our objective would provide a dual purpose secondary discharge hose, one which is sufficiently flexible to eliminate the need for a rotatable fitting. Additionally, the operator can vary the bucket's capacity by variably connecting the distal end of the hose below the rim on smaller wild fire buckets, eliminating the need to choke the bucket with a cinch strap, which is currently the method. Effectively, this system of adjusting the bucket's capacity is functional for smaller wild fire buckets only, due to the longer drain down time required for larger buckets. This system would be beneficial to buckets such as the 80-90-100-120 gallon variations where 10-30% drain down times are operationally satisfactory.

Another specific objective of this invention was to improve the servicing of the valve in addition to the bucket's general serviceability. A worst case scenario would be removing a damaged valve during field operations. Two factors make this service operation very difficult on prior art buckets. Firstly; the entire umbrella-like bucket opening device, the central hub, spokes, restrainer cable, and deployment cable must be removed to gain access into the bucket to remove the valve's circular ring of fasteners. The valve is firmly sealed with butyl tape, bonding the valve collar's resilient material to the bucket shell. Removing the valve, breaking the butyl bond is not only difficult but messy, the butyl compound sticking to anything it touches. Most often breaking this bond results in ripping chunks out of the valve's resilient sealing collar, with some portions remaining adhered to the shell of the bucket. The torn out chunks of the resilient sealing valve collar must be removed, the butyl compound removed and replaced before the new valve can be installed; it's a messy and difficult operation. After the new valve has been installed, the central hub, spokes, restrainer cables and bucket deployment cable must now be re-installed.

The centrally open top of our “Wild Fire Bucket” invention, resolves the first difficulty, while the valve sealing resilient collar's design and installation resolves the latter. The improvement being a two piece sealing device each having a resilient collar. The bottom collar is sealed to the bucket shell in the traditional manner with a butyl type compound, while the upper collar is permanently attached to the valve body. A ring of fasteners bring the collars into sealing abutment. Removing this type of valve is a simple matter. It's done without disturbing the butyl seal which remains firmly in place during the procedure. The valve can now be replaced by simply turning the bucket upside down and reaching into the bucket. No longer is it necessary to climb into the bucket to change a valve. The new design resolves a long standing service issue.

Another servicing problem exists with Prior Art Buckets, when seriously damaged, the bucket shell or body requires opening it up and cutting out ripped, torn, holed, or otherwise damaged panels for their replacement. To do this, requires removing the valve from the bucket. Our design improvement now once again allows the valve to be easily removed without damage. Now, the resilient sealing collars have a fabric cover which protects their soft resilient sealing material. The lower collars can be removed from the bucket's shell or body without being torn or damaged by the butyl sealing compound which resists the removal. The covering saves the lower collar under this servicing.

On occasion water bucket equipped helicopters are dispatched to transport emergency supplies to “Wild Fire Ground Crews”, i.e. back packs, tools and equipment, potable water, first air supplies, emergency heat shield blankets and bags, etc. Water buckets equipped with constricting hubs and spokes require precious time to stuff the cargo in and through the narrow spaces between the hub and spokes but even more time, sensitive life threatening time, to arduously retrieve the precious cargo under extreme operational conditions.

Another objective of our Rim Opening Device Invention was to design the bucket mouth centrally open, free of obstructions facilitating efficient emergency cargo transport.

However, the single most significant aspect of a centrally open bucket mouth—bar none—is the bucket's emergency adaptability to extract “Wild Fire Ground Crew” Personnel from harms way. Trapped and encircled by a fire storm, it literally becomes a dire straits emergency life saving platform, the centrally open mouth providing firefighting ground crew emergency access into the bucket for safe extraction. Never in the history of collapsible water bucket design and technology has this life saving feature been obtainable.

### SUMMARY OF THE INVENTION

The invention reduces the difficulties and disadvantages of the prior art by providing an aerial fire fighting bucket to be equipped with a Rim Opening Device which has its centrally open top free of centrally located hubs and spokes which extend radially therefrom to the walls of the bucket to which suspension lines and support cables can on occasion become entangled therein. The Rim Opening Device of this invention being a horizontally arranged closed plane, preferably in the form of a closed plane polygon that becomes a circumferential structural member which reinforces the bucket rim from body impact and hazardous operational conditions. This invention, Rim Opening Device, utilizes heavier components on one side of the bucket than on the other side, ie, material selected from a group of light weight materials such as aluminum, magnesium, titanium versus heavier materials such as steel, stainless steel, brass, bronze, which provide the differential. The differing specific gravity quotions provide sufficient weight differential to provide an offsetting tipping action. Bulky weights bolted to the side wall of the bucket, which is the case with prior art, can cause air flow disturbances, suspension line entanglements and leakage. The Rim Opening Device aerodynamics positioning within the bucket adjacent the rim does not deflect and re-direct high speed airflow into the bucket which would generate water loss as is the case with prior art hubs and spokes which protrude above the bucket rim. Prior art difficulties with abrasion on the resilient sealing lip material caused by purse line travel has been substantially reduced by providing a conformable abrasion cover to the upper portion of the sealing lips above the essentially centrally located purse, line passageways.

A collapsible fire fighting bucket according to the invention comprises an open bucket body of pliable material, a tubular extension made of pliable material, a harness for suspending the bucket from the aircraft, and a releasable support for releasably supporting the tubular extension. The open bucket body has a weighted and reinforced upper rim to facilitate filling from an open body of water, a side wall extending downwardly from the rim, and a bottom cooperating with the side wall and having an opening. The tubular extension extends from the opening in the bottom and has a free end formed with a discharge port to serve as a dump valve. The discharge port has a sealing lip which forms two opposite lip portions which are brought into sealing engagement with each other for minimizing water leakage from the tubular extension. The harness comprises the connector for connecting to the aircraft and a plurality of first flexible tension links connected between the bucket and the connector. The releasable support comprises a second flexible tension link co-operating with the opening in the tubular extension for holding the tubular extension in a raised position in which the free end thereof extends upwardly from the bottom with the discharge port position below a full-water level in the bucket. The support means is releasable for allowing the tubular extension to extend downwardly from the bottom of the bucket for dumping the water.

Servicing if the tubular extension valve has been improved by the addition of a two collar sealing means between the bucket body and the tubular extension. A secondary discharge hose provides both a filling source for ground crews and a third method of adjusting the capacity of small wild fire buckets.

The centrally open bucket top provides easy access into the bucket for general cargo transport and wild fire ground crew safe emergency extraction, flip down jump seats and safety harnesses provided therein.

A detailed disclosure following, related to drawings, describes a preferred embodiment of the invention which is capable of expression in structure other than that particularly described and illustrated.

### BRIEF DESCRIPTION OF THE DRAWINGS

FIG. 1

Is a side elevation of a complete bucket, partially sectioned and fragmented, means of suspension and control, a portion of the dump valve in the fully retracted closed position, in full outline and fragmented in broken outline in the open extended or discharge position, a section of the Rim Opening Device with its lifting cord, first, second and third circumferential tension links, and first, second and third tension links in fragmented and sectional outline, rim opening device restrainer camlocks, bracket omitted for clarity purposes, see FIG. 4.

FIG. 2

Is a simplified plan view perspective of the bucket fully deployed in the open position, the tubular extension withdraw, the Rim Opening Device shown dimensioned around the bucket rim, and the cinch strap slideably received in loops dimensioned around the middle of the bucket shell.

FIG. 3

Is a simplified side elevation of a longitudinal panel detailing; the rim, collar, (first circumferential tension link), collar support rope, cinch strap, cinch strap loop, first flexible tension link extension upper and lower connectors loops, and the bottom chain (third flexible circumferential tension link).

FIG. 4

Is a simplified inside elevation of the bucket showing the Rim Opening Device in the collapsed mode, its lifting cord, restraining camlock, fixed end and free end connectors, mechanical swing arm adjuster, and lifting harness all shown in full outline, hidden features shown in broken outline.

FIG. 5

Is a simplified plan view drawing which shows the concentric outward development of the Rim Opening Device and the shell of the bucket.

FIG. 6

Is a cross sectional side elevation of one half of the prior art sealing lips complete with the abrasion resistant covering improvement 125.

FIG. 7a-7b

Is a simplified side elevation of a slideably adjustable trimming weight shown in full outline and internal embodiments shown in broken outline.

FIG. 8a-8b-8c

Are simplified plan and side elevation drawings of the Rim Opening Device free end connector, fixed end connectors being upside down therefrom.

FIG. 9

Is a diagrammatic side elevation of a deployed emergency extractor jump seat complete with seat belt harness.

FIG. 10

Is a fragmented side elevation of the bucket body showing the rigid through body shell bulkhead fitting and flexible secondary discharge hose and vertically adjustable bracket. The tubular extension valve is shown in exploded view to show both upper and lower collars, abrasion coverings and the sealing compound.

FIG. 11

Prior Art tubular extensions 19, lower sealing collar 77, is a single piece of resilient neoprene folded over and sewn to the bottom of the tubular extension 19. Butyl sealing compound 56, then binds the tubular extension to the bucket body.

### DETAILED DESCRIPTION

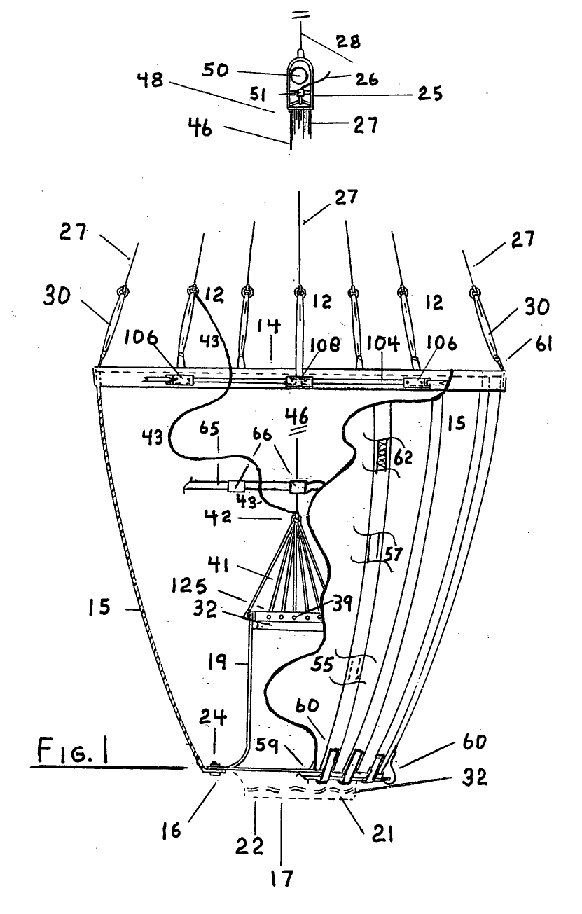

FIG. 1

A fire fighting bucket 10, according to the invention bears many similarities to the earlier fire fighting buckets as disclosed in the aforementioned CA 1,232,889 CA 1,231,311 and U.S. Pat. No. 4,474 245, U.S. Pat. No. 4,576,237 all of which have expired, the disclosures of which are incorporated herein by reference. A brief description of some prior art aspects of the bucket follows, and additional details can be found from the above references. Drawing reference numbers below 100 refer to prior art, three digit reference numbers are new art which are the subject of the claims of this invention.

The bucket 10, has an open bucket body made of tough pliable material, and has an open upper rim 14, to facilitate filling from an open body of water, ie, by dipping into a lake. The bucket has a sidewall 15, extending downwardly from the rim 14, and a bottom 16, cooperating with the sidewall and having an opening 17. A tubular extension 19, made of pliable material is shown in a retracted position extending upwardly into the bucket from the opening in the bottom, and has a free end portion 21, formed with a discharge port 22, to serve as a dump valve. In FIG. 1, the tubular extension is shown fragmented in full outline in the retracted or raised position, and is also partially shown in broken outline in an extended or lowered position, extending downwardly from the bucket with the dump valve open to permit discharge of water from the bucket.

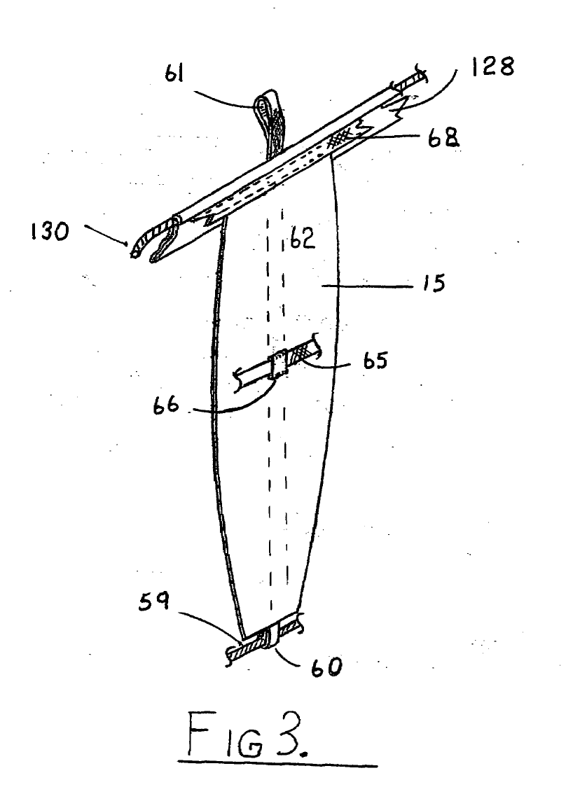

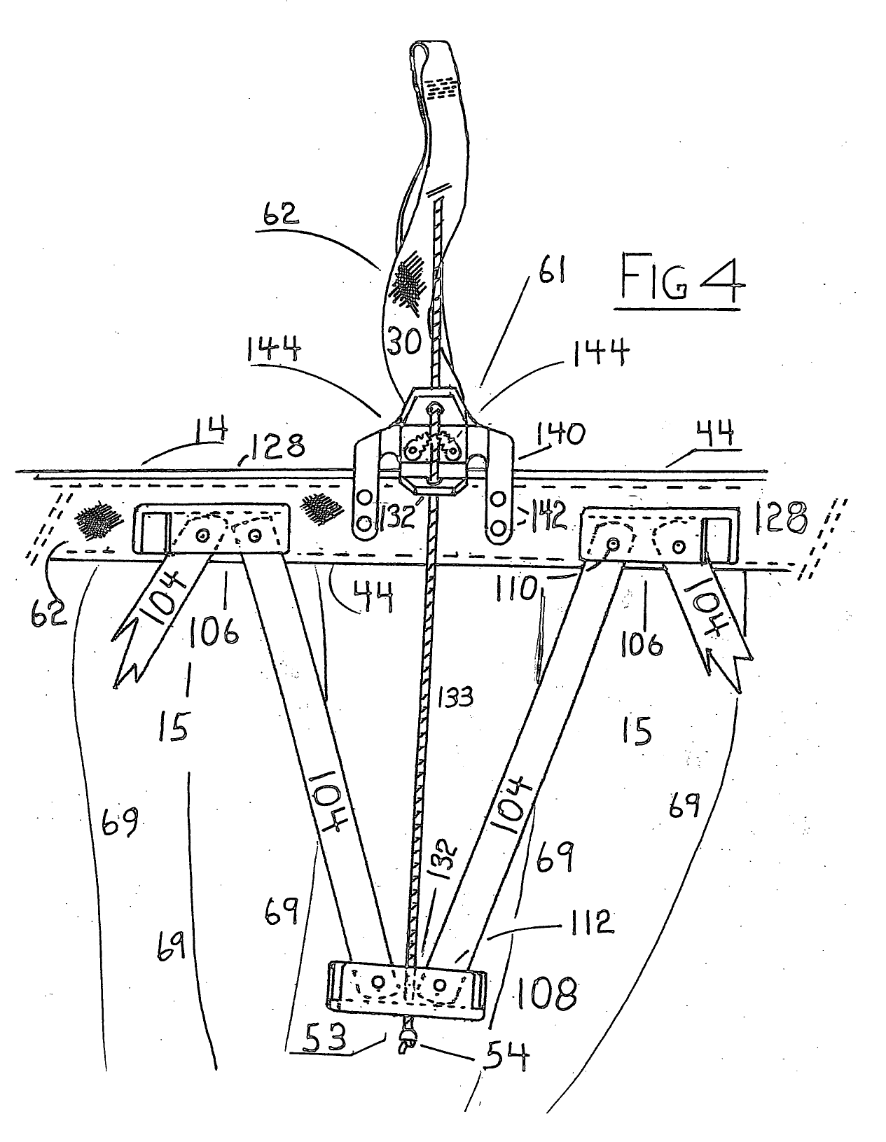

The bucket assembly 10, also includes a harness for suspending the bucket from an aircraft, the harness comprises control head connector 25, which also serves as a connector for connecting to the aircraft, not shown, and a plurality of first flexible tension links 27, first flexible link extension connectors, which connects to the first flexible tension link on extensions upper connectors loops, the-between on and extension, “i.e” on the extensions, shown in FIG. 3, reference 61. The first flexible tension link extension 62, a webbing belt, has upper and lower connector loops 61, and 60, sewn to a pliable material strip, not shown, which is welded to a separate pliable material strip 41 which forms a pocket for a batten 57, all of which are welded to the outer side wall 15. The lower connector loops 60, cooperates with the third circumferential tension links 59, a chain, which supports the bottom of the bucket. Support cables, referenced are connected to the control head connector 25. The control head functions similarly to that disclosed in the above mentioned patents and in particular has a spring reel 50, a trip mechanism 51 for holding and releasing the reel, and controls for remote operation, refer to the above noted patents for a more detailed description of the control head 25. The harness also includes a plurality of Rim Opening Device lifting cords 133, FIG. 4, connected to cooperate with the free end 103, of the Rim Opening Device 100.

The first flexible tension links 27, are connected to both the flexible tension link connector 30, and the Rim Opening Device lifting cords 133, cooperating in such a manner that the first flexible tension links receive the weight of the bucket assembly 10, and its water cargo rather than the Rim Opening Device 100, or its lifting cord 133.

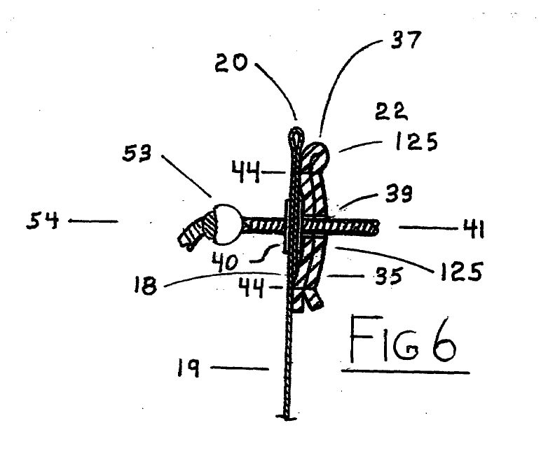

The discharge port 22, FIG. 1, has a sealing lip 32, extending circumferentially, there around to form two opposite sealing lip portions 35 and 36, FIG. 6 which are brought into sealing engagement with each other for minimizing water leakage from the tubular extension. The tubular extension 19, has a plurality of openings reinforced with grommets 40, the openings in the tubular extension 19, are aligned with a corresponding plurality of centrally placed openings through the sealing lips 35 and 36, which co-operates with a plurality of third flexible tension link purse lines 41, in a straight line downwardly from the second flexible tension link 46, connector 42, (as compared to prior art hubs which divert the lines causing the tubular extension to be kinked, as shown in pages 17, 41, etc. of SEI Industries Ltd. Bambi Bucket Manual dated April 1999). The second flexible tension link 46, is connected to the control head 15, which is used to control loading and discharging of water. Full operational details are described in the above noted patents.

The purse lines 41, FIGS. 1 & 2, alternatively enter the tubular extension 19, passing through both sides of the tubular extension 30,and both sealing lips terminating in a ball stop 53, FIG. 6, secured to the terminal end of the purse line 41, with a knot 54, all of these dump valve components being, prior art.

In FIG. 6, the tubular extension 19, is folded over, then pierced with a plurality of grommets 40, with its terminal end 20, being sewn to the wall of the tubular extension. The resilient sealing lips are initially pierced with a plurality of purse line passageways which are aligned with the plurality of grommets 40, in the tubular extension 19, through which the purse lines 41, co-operate. A purse line ball stop co-operates with the purse line to provide an end stop which co-operates with the side wall of the tubular extension 19, to limit purse line travel and applies pressure, compressing the sealing lips when under tension from the third flexible tensions link.

The improvement to prior art sealing lips is the addition of a means to reduce abrasion, i.e. an abrasion cover 125, on the soft resilient sealing lip material which was exposed to purse line travel, as was the case with prior art as described in the previously noted patents.

As described in the above noted patents the bucket 10 has two circumferential means to adjust the capacity of the bucket. Its side wall 15, has a plurality of batten pockets 55, dimensionally spaced apart and arranged longitudinally between the bucket rim 14, and the bottom of the bucket 16. Battens 57, inserted therein provide stiffness to the side wall 15, to variable bulge outwardly when the bucket is lifted out of the water, providing variable filling capacities. The upper ends of the battens terminating at the first circumferential tension link, ie, the collar 128 of the bucket, the lower ends terminating adjacent the third flexible circumferential tension link 59, a chain, which passes through loops 60, FIG. 3, on the terminal ends of a plurality of First flexible tension link extensions 62, ie, the terminal end of the longitudinal webbing belt sewn to side wall panel strip 63, which is welded longitudinally to the side wall panel 15.

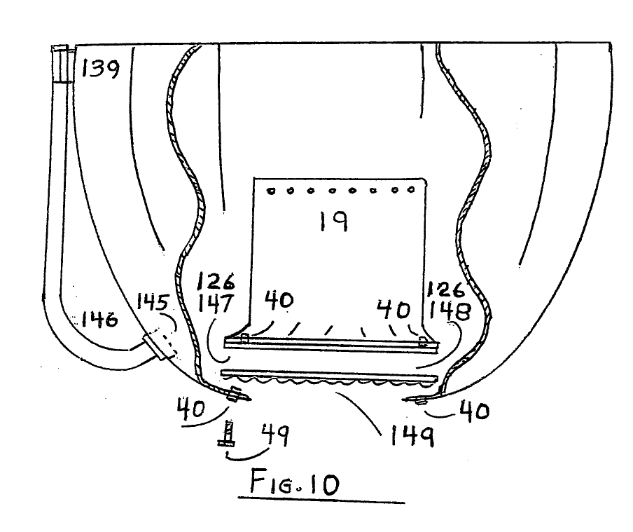

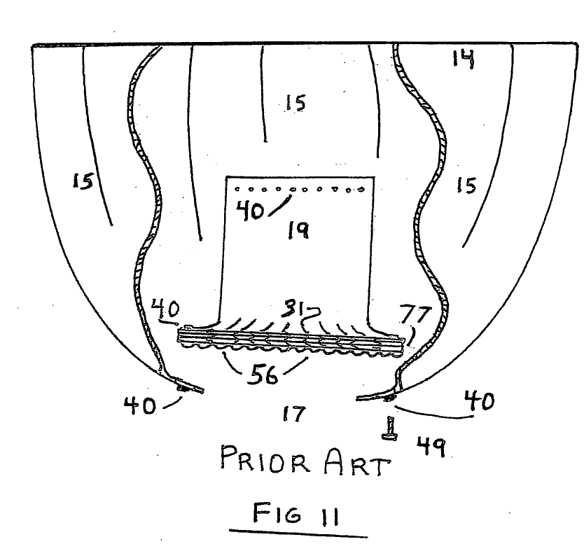

FIG. 10

Additionally smaller “Wild Fire Water Buckets” 10 capacity can be adjusted by a third method when equipped with a secondary external delivery hose. The hose primarily being utilized by ground crews to fill holding tanks, back pack, etc. Prior to being utilized for this purpose the distal end of the flexible second delivery hose is attached to the bucket's rim to maintain a full fill. When incrementally lowered therefrom the capacity is accordingly adjusted to meet helicopter capacity.

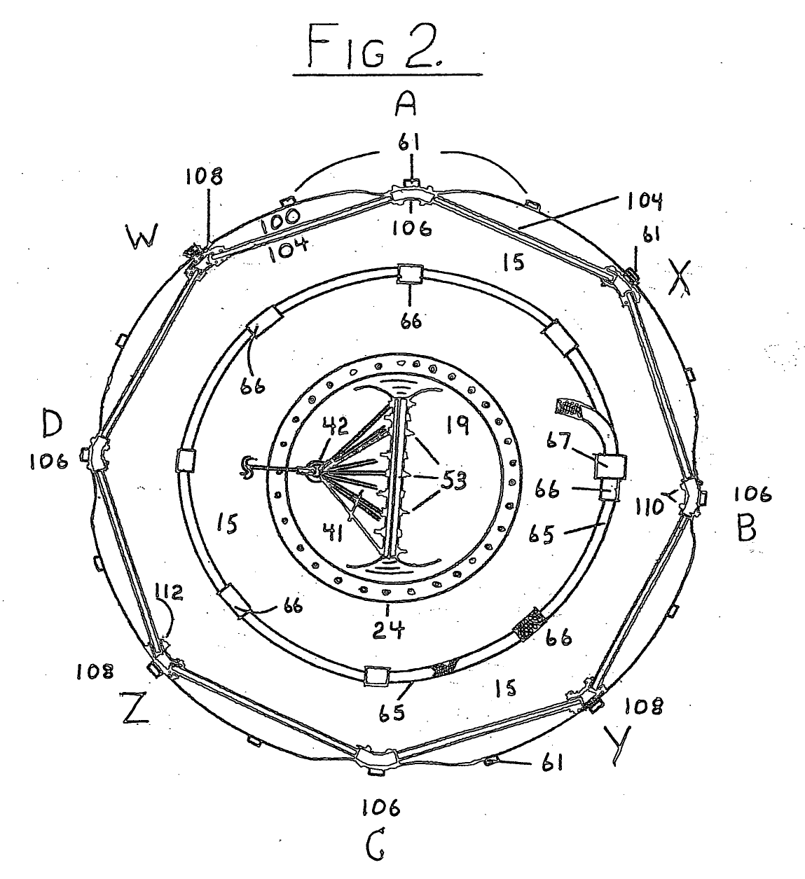

The third circumferential tension link 59, being a heavy chain or cable extends around the bottom 16, through loops 60, to be adjustably connected and tensioned to partially support the weight of the bucket. The weight of the third circumferential tension link facilitates rapid sinking of the bucket into a body of water. The off center weight of the Rim Opening Device causes the bucket to unbalance, falling over to its heavier side so as to rapidly immerse the rim 14, below the surface which facilitates filling the bucket. The second circumferential tension link provide another means of variably adjusting the capacity of the bucket, a cinch strap 65, FIGS. 1 and 2, circumferentially arranged inside the bucket is slideably received through a plurality of loops 66, attached midway up the inner side wall 15, a buckle 67, FIG. 2, secures the terminal ends of the cinch strap 55. The cinch strap 65, is utilized to adjustably vary the size of the bucket capacity to match capability of the aircraft or other operational conditions.
1. A collapsible fire fighting bucket to be suspended from an aircraft and to be filled from an open body of water, the bucket comprising:
   (a) a bucket body made of pliable material and having an upper rim, a side wall, and a bottom;
   (b) a dump valve in the bottom;
   (c) upper rim stiffening means;
   (d) means for suspending the bucket from the aircraft;
   (e) capacity adjusting means around the side wall for adjustably restricting the circumference thereof and thereby reducing the capacity of the bucket.
2. A bucket as claimed in claim 1, wherein the capacity adjusting means is a circumferential flexible tension link arranged either around the outside or inside wall of the bucket and a clamping device for adjusting the effective length of the circumferential flexible tension link.
3. A bucket as claimed in claim 2, wherein the circumferential flexible tension link is a calibrated cinch belt slidably received in belt loops around the side wall of the bucket and the clamping device is a buckle.
4. A bucket as claimed in claim 1, further comprising side wall stiffening means dimensional such that the side wall remains essentially straight while submerged under a low pulling force, but will bulge outwards while submerged under a higher pulling force, so as to adapt the capacity of the bucket to the load carrying capabilities of the aircraft.
5. A bucket as claimed in claim 4, wherein the side wall stiffening means are a plurality of ribs co-operating with the side wall and extending longitudinally and spaced apart from one another between the upper rim and the bottom.
6. A bucket as claimed in claim 5, wherein the ribs are received in pockets on the side of the bucket.
7. A bucket as claimed in claim 1, wherein the means for suspending the bucket from the aircraft comprise a control head connector adapted to be connected to the aircraft, and a plurality of flexible tension links connected between the bucket and the control head connector.
8. An apparatus as claimed in claim 1 further including ballast means positioned adjacent the upper rim on one side of the bucket for achieving fast submersion during filling.
9. A bucket as claimed in claim 8 further including ballast means positioned adjacent the bottom of the bucket for achieving fast submersion while filling.
10. A bucket as claimed in claim 1, comprising a dump valve in the form of a tubular extension made from a pliable material and extending from the bottom and having the free end formed with a discharge port, the extension being adapted to be withdrawn upwardly into the bucket toward the top thereof, the discharge port being submerged below water in the bucket.
11. A bucket as claimed in claim 1 comprising: a supporting means for releasably supporting the free end of the tubular extension, the supporting means comprising a second flexible tension link holding the tubular extension in its upwardly withdrawn position and to be released for allowing the tubular extension to extend downwardly for dumping the water.
12. As claimed in claim 1 comprising: a resilient lip on the discharge port forming two opposite lip sections into mutual sealing engagement for minimizing water leakage from the tubular extension when submerged, the sealing means cooperating with the second flexible tension link.
13. A bucket as claimed in claim 1, further comprising a plurality of third flexible tension links, each having one portion connected to the second flexible tension link and a remaining portion alternately passing through one or the other sealing lip section for bringing the sealing lip sections into sealing abutment when tension is applied to the second flexible tension link.

### Main Claim

14. A collapsible wild fire water bucket opening device, a Rim Opening Device, which is fitted dimensionally around and inside an upper rim of a pliable aerial firefighting water bucket, to co-operate with the side wall to open and close said bucket.
15. A bucket as claimed in claim 14, wherein the mechanical Rim Opening Device comprises a plurality of mechanical wishbones dimensioned around the bucket rim, each of the mechanical wishbones comprising a pair of mechanical swing arms rotatably connected to co-operate with a pliable side wall to open and close the bucket.
16. A bucket as claimed in claim 15, wherein the plurality of the mechanical wishbones each comprising a pair of mechanical swing arms, each having a fixed end and a free end, each of the mechanical swing arm comprising; a fixed end connector, an arm, a free end connector and a means to rotationally connect said mechanical arms, all of which co-operate with the pliable side wall open and close the bucket.
17. A bucket as claimed in claim 15, wherein a plurality of the mechanical wishbones each comprises a pair of the mechanical swing arms which co-operate with the pliable side wall to open and close the bucket, the fixed end connectors comprising a means to rotatably connect the fixed ends of the mechanical swing arms adjacent the bucket rim.
18. A bucket as claimed in claim 15, wherein the plurality of the mechanical wishbones each comprises a pair of mechanical swing arms which co-operate with the pliable side wall to open and close the bucket, the free end connectors comprising a means to rotatably connect the free ends of the mechanical swing arms in pairs.
19. A bucket as claimed in claim 16, wherein the Rim Opening Device has a lifting cord attached to the free end connector, when tension is applied there to the mechanical wishbones transitions from a closed vertical plane to a horizontal plane concentrically in co-operation with the pliable side wall to open the bucket.
20. A bucket as claimed in claim 19, wherein a first flexible tension links, plurality of suspension lines co-operates with the Rim Opening Device lifting cords to lift the Rim Opening Device into the deployed horizontal position while not placing bucket weight on the Rim Opening Device or its lifting cords.
21. A bucket as claimed in claim 16, wherein each of the fixed end and the free end connectors have an angle of inclination which produces a concentric outward development of the Rim Opening Device when tension is applied to the lifting cords.
22. A bucket as claimed in claim 14, wherein the Rim Opening Device lifting cords have a means to hold open the bucket against the weighted wishbone arms which could collapse the bucket unexpectedly, when tension on the first flexible tension links is released.
23. A bucket as claimed in claim 16, wherein each of the free end connectors comprising; tracts for receiving the mechanical swing arms, a means for rotationally connecting the mechanical swing arms, a rotational limit stop to co-operate with and eliminate overcentering the mechanical swing arms above the horizontal plane, a means to locate the fixed end connectors adjacent the bucket's rim, a means to connect the lifting cord, and an angle of inclination are utilized to guide the mechanical swing arms concentric development of the Rim Opening Device's opening and closing of the bucket.
24. A bucket as claimed in claim 16, whereas the fixed end and the free end connectors have similar angles of inclination, size and shape, the free end connector is installed upside down as to the fixed end connector to facilitate upward and concentric development of the Rim Opening Device.
25. A bucket wherein the ballasting means to achieve a fast tipping action and submersion while filling is accomplished by a weight differential on opposite sides of the Rim Opening Device; the deployed plurality of interconnected mechanical wishbones, the fixed end connectors, the swing arms and the free end connectors have a higher specific gravity quotient or are heavier on one side of the Rim Opening Device than on the other creating the ballasted weight differential which promotes fast tipping and submersion.
26. A bucket as claimed in claim 25, wherein the tipping weight differential is dimensioned over about a 180 degree arc located adjacent the rim to achieve a torquing, quick tipping action and fast submersion during filling.
27. A bucket as claimed in claim 16, wherein the fixed end connectors are located adjacent the bucket rim, the mechanical Rim Opening Device is aerodynamically dimensioned; leeward, therein, below the rim, which co-operates with forward movement of the bucket during flight to produce a clean directional airflow above the bucket, not deflecting airflow therein.
28. A bucket as claimed in claim 14 wherein the deployed Rim Opening Device co-operates aerodynamically with its' dimensioned configuration within the centrally open top of the bucket to substantially reduce water loss during flight.
29. A bucket as claimed in claim 14, wherein the perimeter of the pliable rim is circumferentially and structurally supported by the weighted, deployed open, Rim Opening Device which co-operates with the tipping action to knife the leading edge underwater, facilitating rapid submersion and filling.
30. A pliable bucket as claimed in claim 14, wherein the deployed Rim Opening Device opens concentrically to define a structurally unrestricted centrally open round mouth which co-operates with the bucket body to receive general cargo.
31. A bucket as claimed in claim 14, wherein the deployed Rim Opening Device opens up concentrically to define a structurally unrestricted centrally open, essentially round mouth to co-operate with the bucket body to receive emergency evacuees, a flip down, pliable, emergency extractor jump seat and a seat belt harness co-operating to secure the evacuees for extraction from harms way.
32. A bucket as claimed in claim 14, wherein the tubular extensions resilient sealing lips have an abrasion resistant covering.
33. A bucket as claimed in claim 14, wherein the third flexible tension link purse lines are held in a straight line to the second flexible tension link to prevent kinking the tubular extension.
34. A bucket as claimed in claim 14, wherein the ballasting means to achieve rapid submersion during filling is structurally integral to the buckets mechanical opening device.
35. A bucket as claimed in claim 25, wherein the ballasting means to achieve a quick tipping action is arranged circumferentially and horizontally adjoined in union with, conterminous with, and contiguous with the buckets uppermost extremity, its rim, to maximize the ballasts Metacentric Height, thereby densely concentrating the gravitational tipping moment at the buckets upper rim.
36. A bucket claimed in claim 25, wherein the Metacentric Height of the ballast is consistent with the buckets maximum gravitational tipping moment.
37. A bucket as claimed in claim 14, wherein the valves lower seal, to the bucket's bottom, comprises of more than one independent resilient sealing collars, the lower one being permanently sealed to the inside of the bucket bottom and another being attached to the bottom of the valve, the two halves being removably fastened together, effecting a second seal, free of sealing compound.
38. A bucket as claimed in claims 14, wherein, when the valve is in the upright withdrawn position within the bucket, the resilient sealing lips are thinner above the grommetts through which the purse lines pass, than below them.
39. A bucket as claimed in claim 37, wherein the valves lower resilient sealing collars have a covering, such as fabric.
40. A bucket as claimed in claim 14, wherein the bucket has a secondary discharging means; a rigid through bucket shell, bulkhead fitting, affixed to the bottom of a side panel, to which a sufficiently flexible, manually accessible hose, is affixed therefore.
41. A bucket as claimed in claim 40, wherein the distal end of the flexible discharge hose is open and has means to be variably connected vertically to the side of the said bucket.
42. A bucket as claimed in claim 40, wherein the distal, open end, of the secondary discharge hose can be variably affixed below the bucket rim to variably adjust the level of water in a bucket, a means of calibration being provided therefore.
43. A bucket as claimed in claim 15, wherein the length of the wishbone arms of the opening device are adjustable.
44. A bucket as claimed in claim 15, wherein the length of the structural arms adjustably co-operate with other structural members of the opening device, and the body of the bucket to apply circumferential tension at the bucket rim.
45. A bucket as claimed in claim 26, wherein centers of the circumferentially arranged tipping weights are in a vertically aligned plane when the bucket has been tipped horizontally, maximizing the downwardly force, to co-operate with the circumferentially tensioned rim of the bucket, to achieve quick submersion and filling.

A Rim Opening Device 100, is utilized to mechanically open and close the rim of this aerial fire fighting bucket assembly 10. The Rim Opening Device 100, facilitates automatically opening the bucket assembly 10, for essentially very quick deployment. The Rim Opening Device 100, opens and closes concentrically and can be easily opened either by hand or automatically when under tension from an aircraft.

The Rim Opening Device 100, preferably has a plurality of three or more interconnected mechanical wishbones or at least two independent wishbone mechanisms 102, FIG. 4, which have their fixed end connectors 106, FIG. 2, connected to and circumferentially dimensioned and spaced apart around the inside of the bucket rim 14, FIG. 4 shows a diagrammatic side elevation of interconnected wishbones partially open.

A primary focus of this invention is a Rim Opening Device 100, mechanism which preferably has interconnected wishbones, the detailed description will focus on that embodiment.

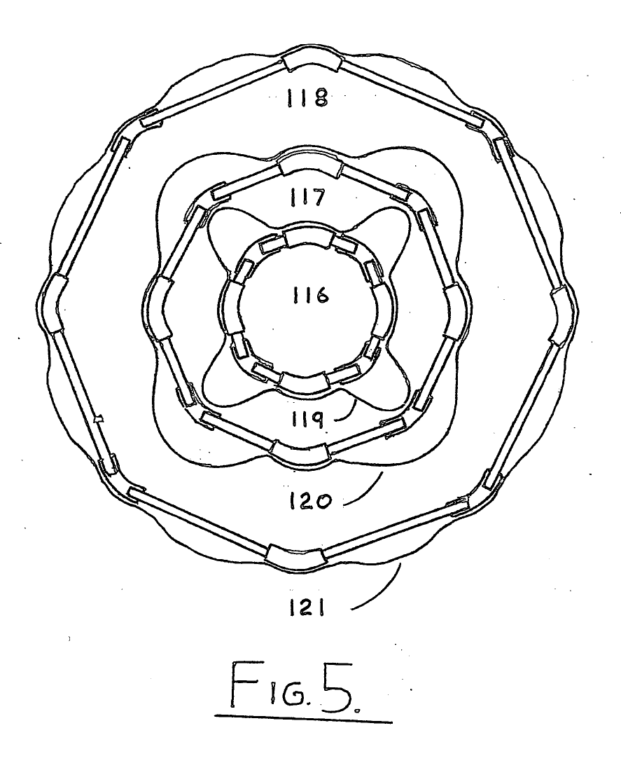

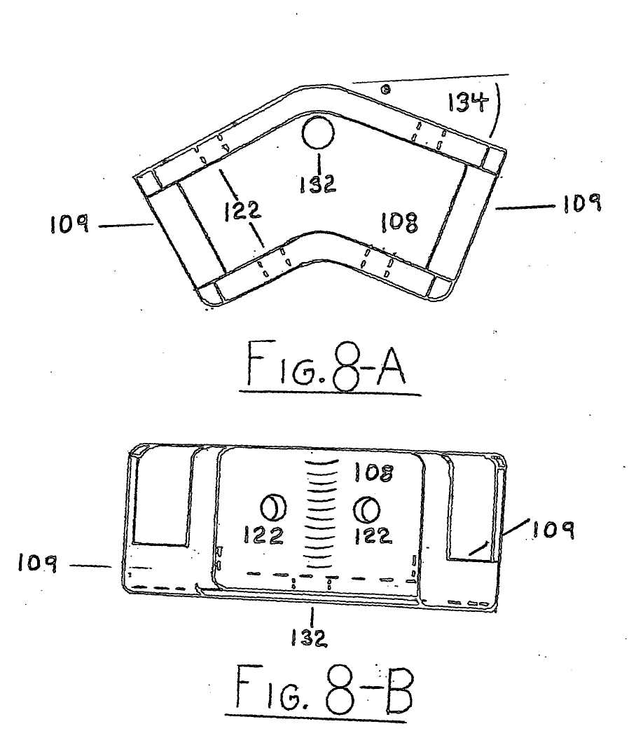

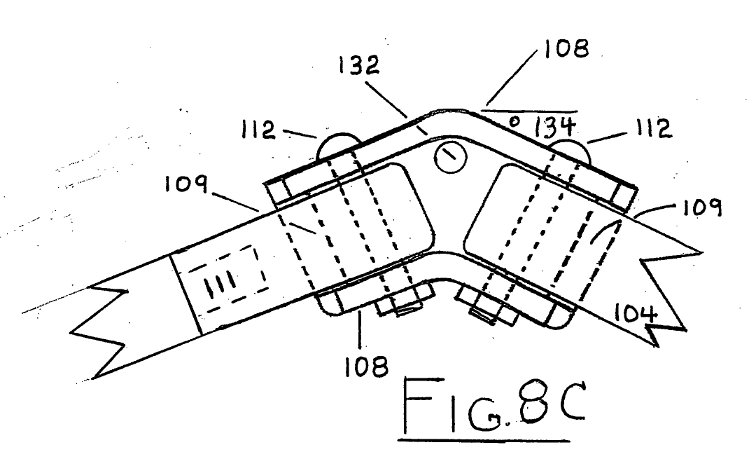

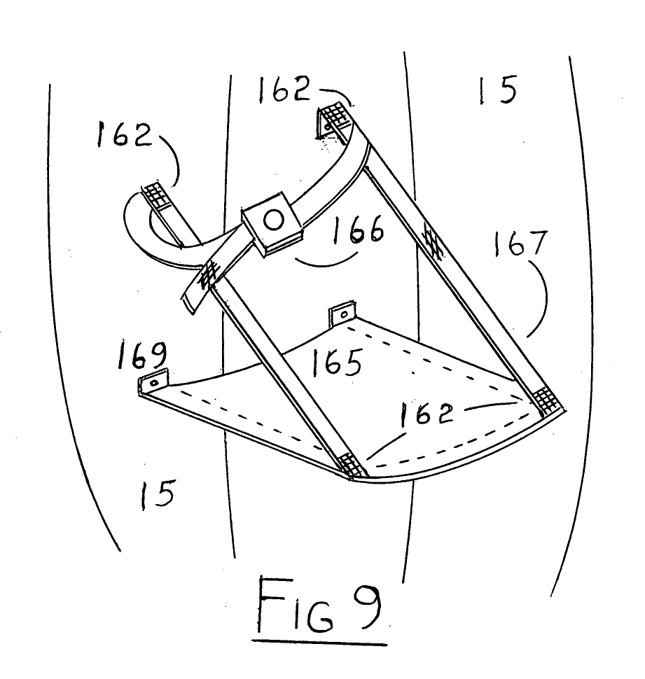

The Rim Opening Device mechanisms 100, FIG. 4, has interconnected wishbone devices 102, which share one half of each adjoining fixed end-upper wishbone connectors 106, which cooperate with each other, their mechanical swing arms 104, being rotatably fixed to the fixed end connector 110, their arms extending therefrom to be received by the free end connector 108, and rotatably fixed 112, thereto. The rotatable means which connects the mechanical swing arms 104, to the fixed end 106, and free end connectors 108, are round fasteners 110 and 112, such as a nut and bolt, or a pin and retainer, refer to FIGS. 4, and 8C. A lifting cord 133, FIG. 4, is connected to and cooperates with the free-end connector 108, which cooperates with the mechanical swing arms 104, which co-operatively push against the fixed end connectors 106, when tension applied to the lifting cord 133, to cooperate with the side wall 15, opening the bucket. The lifting cord 133, passes through a camlock bracket 140, FIG. 4, attached to the bucket 10, rim 14, guiding the lifting cord 133, through a spring loaded camlock 144, which retains the Rim Opening Device in the deployed open position free of any bucket weight. FIG. 5, is a three stage sequential diagrammatic plan view showing the concentric transitional development of the Rim Opening Device 100, and outgrowth of the bucket rims contour.

Each wishbone arm 104, is equipped with a turnbuckle type 113, adjusting method having both left and right hand threaded ends to variably adjust the length of the wishbone arms 104. Lengthening the arm increases tension on the first flexible circumferential tension link “ie” the collar 128.

FIG. 5 shows a plan view of the Rim Opening Device 100, in its collapsed mode 116, and similarly a plan view of the Fire Fighting Buckets 10, contour of the upper rim 14. As the bucket 10, is opened the Rim Opening Device 100, transitions concentrically from 116 to 117, to fully open 118. The bucket rim 14, and bucket sidewall 15, develops outgrowth contours 119, to 120, to 121, in co-operation with the outwardly concentric development of the Rim Opening Device 100, completing full form development.

All mechanical wishbones 102, have fixed end connectors 106, affixed adjacent the bucket rim 14, and cooperate with the free end connectors 108, when under tension to transition from or to the collapsed state.

Both the fixed and free end connectors preferably embody an angle of inclination FIGS. 8A and 8C, reference 134, in their design, and preferably incorporate identical angles of inclination on the fixed and free end connectors. When the bucket grows outwardly in a horizontally developing plane it is preferable that the rising free end connectors guide their own development and that of the mechanical swing arms 104, in the vertical plane. However, other variations could be made to function. The free end connector 108 is installed upside down as to the fixed end connector 106, FIG. 4. The wishbones angle of inclination FIG. 8A and 8C,—134, converts vertical lifting moments, i.e. tension on lifting cord 133,—to vertically and horizontally thrust open the Rim Opening Device 100, in co-operation with the side walls 15, of the bucket.

A Rim Opening Device 100, having four interconnected wishbones 102, requires four fixed 106, and four free end connectors 108, with matching angles of inclination to produce an eight sided polygon figure ie, FIG. 2, connector points A, X, B, Y, C, Z, D, W.

Connector points A, B, C, D FIG. 2 are fixed end connectors while W, X, Y, Z are free end connector points FIGS. 2 and 5.

In the same context a bucket having a Rim Opening Device 100, having five wishbones would produce a ten sided polygon while one having three wishbones would produce a six sided polygon figure and so on.

Aerial fire fighting water buckets are sized to meet the lifting capability of individual helicopters, approximately fifteen different sizes are common to the industry. Accordingly, the capacities and dimensions of the buckets are varied to comply with the required specifications. Various sized buckets each equipped with a wishbone type Rim Opening Device as described herein have a interlocking dimensional and structural relationship between the wishbone connectors angle of inclination and both the diameter of a drawn circle radially connecting the distal ends of each segment of a horizontally arranged polygon in the form of a Rim Opening Device, and the number of segments contained therein.

For Example Only: Take a Rim Opening Device 100, equipped fire fighting bucket and benchmark its diameter—as described above—and effect dimensional changes to firstly its diameter and, secondly the number of segments (wishbones) contained therein
Example (a) If we change both the diameter and the number of segments we change both the angle of inclination and the dimensions of the segments.
Example (b) If we only change diameter, the angle remains the same, but the segments are dimensionally altered.
Example (c) If we only change the number of segments then we change both the angle and the dimensions of the segments.

The above examples represent a interlocking relationship which can be expressed numerically.

All prior art buckets utilize attached weights of one description or another to achieve quick tipping action and to submerge the bucket quickly in an open body of water for filling. The Rim Opening Device 100, solves this problem in a unique but simple way. The Rim Opening Device provides sufficient tipping action by utilizing in its construction, materials which have significant differences in their specific gravities when compared to each other, ie, aluminum versus steel, light versus heavy. Mechanical swing arms and connectors made from a heavy metal are arranged on one side of the bucket while lighter materials are similarly utilized for the opposite side. The weight differential being sufficient to achieve the desired results. The geometry of the tipping action benefits by the placement of the tipping weight differential being placed strategically at the rim, thereby slightly reducing the amount of weight required to create a desired tipping action.

The Rim Opening Device 100 differentiates itself from prior art flexible bucket ballasting means by contiguously enjoining the ballast circumferentially and horizontally in union with the buckets upper terminus, thereby densely concentrating and centralizing the tipping action by optimizing ballast positioning contiguously at the buckets upper distal extremity not nearly adjacent or below it which is the case of all prior art flexible buckets.

The circumferential and horizontal placement of centralized ballast in contiguous union with the bucket rim 14, optimizes the gravitational moment while maximizing its Metacentric Height to achieve superior tipping, filling and in flight characteristics. Vertically arranged ballast blocks or bags placed merely adjacent or well below the rim 14, as is the case with all prior art flexible buckets has a much lower gravitational moment and subsequent lower Metacentric Height which translates into slower tipping, filling and poorer in flight characteristics. These differences can be mathematically calculated using common, proven mathematical formulas for aircraft and ship stability calculations.

A Rim Opening Device utilizing materials in its construction which have significantly different specific gravities as described above provide additional benefits. It is no longer necessary to punch several holes through the side wall of the bucket to secure bulky ballast bags or blocks, all of which can cause leakage or damage to the shell of the bucket when bulky external weight blocks or bags encounter hang ups or when harness suspension lines become entangled with protruding weights. Weight blocks externally attached to the bucket side create disturbance of air flows around the bucket when in flight causing tendencies for bucket rotation. The elimination of externally affixed bulky weights and their fastener straps from the outside shell of the bucket serves to provide a cleaner, more asethetic, aerodynamic form, reducing bucket rotation accordingly. Additionally, Rim Opening Device equipped buckets as described herein, eliminate the need for internal bracings such as hubs and spokes which can also cause suspension & harness line entanglement.

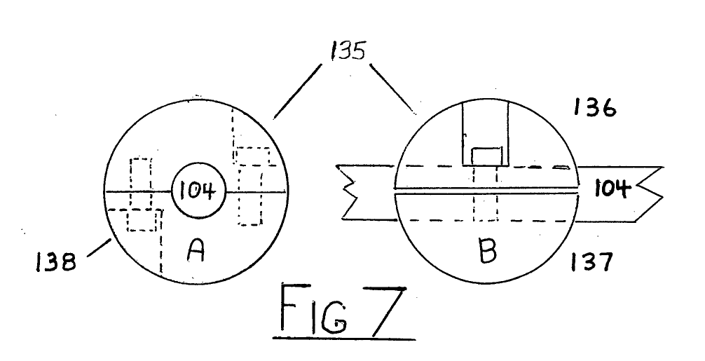

Trimming weights 135 FIG. 7, are slideably adjustable in the mechanical swing arms 104, they have an upper 136 and a lower half 137, and are secured by trimming weight fasteners 139. They have two purposes (a) to provide aerodynamic trimming of the bucket 10, (b) to provide an incremental amount of weight to adjust the tipping action.

The Rim Opening Device 100 is installed both below and adjacent the rim 14, out of the direct airflow which passes overhead. Current art buckets as described in CA 2,124,166, U.S. Pat. No. 5,560,429, have their hubs and the tops of their inclined spokes extending above the rim deflecting and re-directing fast moving air into the bucket, agitating the water and causing water loss out.

Another objective of this invention was to improve serviceability, especially associated with servicing the tubular extensions 19, repair or replacement.

The design and installation of prior art tubular extensions make servicing for repair or replacements most difficult, especially if it is to be undertaken during field operations. During manufacture the resilient neoprene collar is folded over and sewn to the underside of the tubular extension 19, a sealing compound applied and it is then bolted to the bucket body 10. Removing the installed tubular extension 19, is made most difficult by the sealing compound, usually large chunks of neoprene are ripped out during the removal process. It is then necessary to remove the sticky compound and damaged neoprene before replacement.

The solution to this problem is to provide two collars, the upper collar FIG. 10, number 147, being sewn to the tubular extension 19, while the lower collar is firmly attached to the bucket body 10, by a sealant. Abrasion covering on both abutting collars protect the resilient neoprene collar material. Fasteners 49, secure the tubular extension valve 19, to the body 10. When servicing is required the fasteners 49, are removed, leaving the lower collar in place, both the upper and lower collars 147, and 148, respectively are free to separate without the mess and damage associated with servicing prior art tubular extensions.

The firefighting water bucket 10, is equipped with flip up-down emergency extractor jump seats 165, hinged to the inside wall 15, of the bucket 10, held in place by velcro strips 162. A seat belt harness 166, and adjuster bucket 168, provide security. A flip up-down discharge port cover 170, (not shown for clarity purposes) hinged to the inside side wall 15, of the bucket 10, is utilized to provide footing.

### Variations and Alternatives

The amount of weight required to provide adequate tipping action is directly related to the size and capacity of the bucket. The offsetting weight coming from the weight differential between lighter Rim Opening Device 101, structural components being on one side, while heavier components being used on the opposing side. Whereas there is a significant difference in the specific gravity quotion of lighter materials, ie, for example, aluminum versus heavier materials, ie, steel. If it is necessary to gain additional weight differential for the larger buckets by varying the materials used in the wishbone arms construction, a heavier solid bar versus a hollow section, a square bar for a round, a rectangular bar for a square bar and an irregular shaped bar for a rectangular bar, etc., additionally trimming weights as shown in FIG. 7, can be utilized.

This invention describes a Rim Opening Device 100, having a lifting cord 133 guided through a camlock device for the purpose of restraining the Rim Opening Device 100, from collapsing when the bucket is empty, or during impact with the water when dipping into the water, or during hard landings. Clearly there are many ways to achieve this connection. The restrainer has only the weight of the Rim Opening Device to hold up, which in turn stops the bucket from collapsing. Any quick connector could be used for this purpose, ie, a light chain and toggle, a cleat, a devise, a closable link or a snap pin located on the free-end connector to restrict movement from the fully open position.

While the specific embodiments and application of the Rim Opening Device 100, has been disclosed herein, the invention encompasses alternatives of the art. Their description which follows utilizes the enclosed drawings and identical reference numbers for easy referral. As stated earlier in detailed descriptions, it is preferred that the Rim Opening Device 100, be installed adjacent the rim 14, and inside the bucket, however other locations can be made to function.

Again, it is preferable that the wishbone 102, be interconnected to form a closed plane polygon when the Rim Opening Device 100 is fully deployed circumferentially around the bucket rim 14. The wishbones 102, being connected to the side wall 15, of the bucket 10, by fixed end connectors 106, each of which has two tracts for receiving mechanical swing arms 104, ie. one from each adjoining wishbone mechanism 102, thereby interconnecting all wishbones to form a horizontally arranged closed plane figure. However, an aerial firefighting bucket as described herein equipped with independent wishbones 102, ones which are not interconnected but are fixed dimensionally, spaced apart, around the bucket rim could be made to functionally open the bucket. The fixed end connectors 106, would each only have one mechanical swing arm 104, tract for securing its own arm 104. It would still open the bucket. The tough pliable bucket side wall between the single fixed wishbone connectors 106, deforms, simulating an angle of inclination, when filled the bucket takes a somewhat symmetrical shape.

There are a number of disadvantages to this alternatives, but it could be made to function. Similarly, Rim Opening Device equipped aerial firefighting buckets not in the form of a closed plane polygon are poor alternatives, but once again they can be made to function with a Rim Opening Device 100.

While the embodiment of a bucket 10, has been disclosed herein as an eight-sided polygon in shape, any bucket shaped in the form of a multi-sided polygon having similar embodiments can be utilized to produce a similar function. Alternative shapes created by varying the number of sides comprising the polygon may be useful to adapt the Rim Opening Device for other applications.

Alternative uses may be made from the Rim Opening Device's mechanism, adapted or re-configured to other useful needs and applications, ie. such as collapsible containers, pliable enclosures, temporary structures, closures, valves.

For example: If we reconfigure a Rim Opening Device 100 and install it upside down in the bottom of a bucket 10, it can be made to function as a multi dump valve which can be opened or closed at the operators discretion. With the fixed end connectors 106, being attached to the bucket side wall 15, adjacent the bottom of the bucket side wall 16, and having a pliable bottom 157, beneath the reconfigured Rim Opening Device 100, equipped with a resilient sealing lip 152, when the free end connector harness 16, is pulled up the Rim Opening Device 100 transitions to a Multi Dump Valve 150, opening the closure, sealing closure between the Multi Dump Valve 150, and the interior of the side wall 15, is accomplished by a pair of opposing resilient sealing lips 154, and 155, when tension on the harness is eliminated, the weight of the water pushes, on the pliable bottom to effect sealing.

The embodiment of this invention for example can be reconfigured into portable, pliable, collapsible structures such as enclosures and collapsible containers. Further mechanical equivalents will be apparent in which elements of the Rim Opening Device 100 are replaced by parts that perform substantially the same function in substantially the same way to achieve substantially the same results and such equivalents are within the scope of the present invention.

### Operations

The bucket in its collapsed state can be transported by helicopter to a staging area for operations. Once unloaded from the helicopter it is necessary to prepare the bucket for its assigned duty. After removal from its carrying bag the bucket needs to be assembled for duty. The lifting cords are pulled up, causing the free end 108, of the wishbones which cooperate with the fixed ends 106, of the wishbones and the side wall 15, of the bucket to be thrust open. The free end 108, of each wishbone rising to the rim 14, the bucket forming a horizontal closed plane which holds the bucket in the open position, spring loaded camlock restrainers 144, being attached for this purpose.

The second circumferential tension link 65,—an adjustable cinch belt—can now be adjusted to meet the lifting capabilities of the helicopter. Markings on tags sewn to the cinch belt 65, guide the operator in the selection process. The belt being slideably received in loops 66, runs around the inside of the bucket terminating with a lockable buckle 67. The operator pulls the belt through the buckle to the desired capacity and locks the buckle. The tubular extension 19, is withdrawn into the bucket body 10, under the force of the recoil spring 50, which applies tension on the second flexible tension link 46, which in turn applies tension on the third flexible tension links 41, which holds the tubular extension 19, upright in the bucket 10, a releasable latching stopper 51, holds the second flexible tension link from releasing the tubular extension. The control head connector 25 complete with suspension lines 27, and remote controls 26, are now connected to the helicopter, not shown.

The bucket 10, is now ready for filling.

The helicopter now flies the suspended bucket to an open body of water. The ballasted weight on the lead side of the bucket and its clean aerodynamics form reduces bucket rotation on the suspension lines 27, during flight. The bucket is lowered on to the lake, its heavier side tipping the bucket over submerging the rim, the weight of the ballasted mechanical swing arms and the weight of the third circumferential tension link 48, acting to quickly submerge the entire bucket.

The helicopter now pulls the bucket up and out of the water, tension being applied to the third flexible tension links 41, and by the weight of the water, ie, hydrostatic pressure acting on the sides of the tubular extension 19, helps the sealing engagement. The releasable latching stopper in the control head connector holds the second flexible tension link from releasing the tubular extension 19. The tension on the third flexible tension link ie. the purse strings, brings the sealing lip 32, into sealing abutment, preventing water leakage from the discharge port 17, which is in its upright position below the water level in the bucket.

Another method of adjusting the fill level in the bucket is to vary the pulling force of the helicopter as it lifts the bucket up out of the water. Stiff battens 57, are dimensioned around the bucket wall 15, in batten pockets 55, arranged longitudinally and remain essentially straight when the bucket is pulled slowly out of the water to bulge outwardly thereafter. This slow pulling action results in a lower level of water in the bucket, as compared to a strong rapid pull which tends to bulge the stiffening battens while still under water, resulting in a higher water level fill.

Additionally, another method of adjusting the fill level in a small bucket is available by means of the secondary discharge hose. Prior to flight, the operator positions the distal end of the hose incrementally below the rim and the hose will overflow accordingly adjusting the fill level parallel to the top of the hose. Ground crews utilize this hose to fill water back pack, water reservoirs, etc. when slung under the helicopter.

The bucket now filled with water is flown to the site of the fire for dumping. The pilot activates a solenoid 52, in the connector control head 25, which releases the tension on the tubular extension 19, which allows it to plunge downwardly under the weight of the water, which evacuates the bucket, now the force of the spring reel pulls the tubular extension back to the upright position within the bucket thereby allowing the bucket to be refilled.

The emergency extractor Jump Seat option should only be used for life saving, dire straits extraction when fire fighting personnel are about to be overrun by a fire storm and when other safe extraction methods are not practical or available. The helicopter operator utilizing a non rotating steel line of sufficient length, would lower the bucket on to the extraction site, lay the bucket over on to its side, slacking the lifting line to facilitate access past the suspension harness which can be parted therefrom.

The centrally open top of the bucket provides easy access into the bucket. The first to enter would flip a discharge port cover down then position him or herself facing outward and the rest of the crew would follow suit. The helicopter now lifts the bucket to the vertical position which allows the crew to arrange themselves into the extractor jump seats which they have deployed, securely strapping themselves into the seat belt harnesses provided. The helicopter now flies the evacuees out of harms way to a first aid or fire base station.

What is claimed is:

1. A collapsible fire fighting bucket to be suspended from an aircraft and to be filled from an open body of water, the bucket comprising:
(a) a bucket body made of pliable material and having an upper rim, a side wall, and a bottom;
(b) a dump valve in the bottom;
(c) upper rim stiffening means;
(d) means for suspending the bucket from the aircraft;
(e) capacity adjusting means around the side wall for adjustably restricting the circumference thereof and thereby reducing the capacity of the bucket.

2. A bucket as claimed in claim 1, wherein the capacity adjusting means is a circumferential flexible tension link arranged either around the outside or inside wall of the bucket and a clamping device for adjusting the effective length of the circumferential flexible tension link.

3. A bucket as claimed in claim 2, wherein the circumferential flexible tension link is a calibrated cinch belt slidably received in belt loops around the side wall of the bucket and the clamping device is a buckle.

4. A bucket as claimed in claim 1, further comprising side wall stiffening means dimensional such that the side wall remains essentially straight while submerged under a low pulling force, but will bulge outwards while submerged under a higher pulling force, so as to adapt the capacity of the bucket to the load carrying capabilities of the aircraft.

5. A bucket as claimed in claim 4, wherein the side wall stiffening means are a plurality of ribs co-operating with the side wall and extending longitudinally and spaced apart from one another between the upper rim and the bottom.

6. A bucket as claimed in claim 5, wherein the ribs are received in pockets on the side of the bucket.

7. A bucket as claimed in claim 1, wherein the means for suspending the bucket from the aircraft comprise a control head connector adapted to be connected to the aircraft, and a plurality of flexible tension links connected between the bucket and the control head connector.

8. An apparatus as claimed in claim 1 further including ballast means positioned adjacent the upper rim on one side of the bucket for achieving fast submersion during filling.

9. A bucket as claimed in claim 8 further including ballast means positioned adjacent the bottom of the bucket for achieving fast submersion while filling.

10. A bucket as claimed in claim 1, comprising a dump valve in the form of a tubular extension made from a pliable material and extending from the bottom and having the free end formed with a discharge port, the extension being adapted to be withdrawn upwardly into the bucket toward the top thereof, the discharge port being submerged below water in the bucket.

11. A bucket as claimed in claim 1 comprising: a supporting means for releasably supporting the free end of the tubular extension, the supporting means comprising a second flexible tension link holding the tubular extension in its upwardly withdrawn position and to be released for allowing the tubular extension to extend downwardly for dumping the water.

12. As claimed in claim 1 comprising: a resilient lip on the discharge port forming two opposite lip sections into mutual sealing engagement for minimizing water leakage from the tubular extension when submerged, the sealing means cooperating with the second flexible tension link.

13. A bucket as claimed in claim 1, further comprising a plurality of third flexible tension links, each having one portion connected to the second flexible tension link and a remaining portion alternately passing through one or the other sealing lip section for bringing the sealing lip sections into sealing abutment when tension is applied to the second flexible tension link.

14. A collapsible wild fire water bucket opening device, a Rim Opening Device, which is fitted dimensionally around and inside an upper rim of a pliable aerial firefighting water bucket, to co-operate with the side wall to open and close said bucket.

15. A bucket as claimed in claim 14, wherein the mechanical Rim Opening Device comprises a plurality of mechanical wishbones dimensioned around the bucket rim, each of the mechanical wishbones comprising a pair of mechanical swing arms rotatably connected to co-operate with a pliable side wall to open and close the bucket.

16. A bucket as claimed in claim 15, wherein the plurality of the mechanical wishbones each comprising a pair of mechanical swing arms, each having a fixed end and a free end, each of the mechanical swing arm comprising; a fixed end connector, an arm, a free end connector and a means to rotationally connect said mechanical arms, all of which co-operate with the pliable side wall to open and close the bucket.

17. A bucket as claimed in claim 15, wherein a plurality of the mechanical wishbones each comprises a pair of the mechanical swing arms which co-operate with the pliable side wall to open and close the bucket, the fixed end connectors comprising a means to rotatably connect the fixed ends of the mechanical swing arms adjacent the bucket rim.

18. A bucket as claimed in claim 15, wherein the plurality of the mechanical wishbones each comprises a pair of mechanical swing arms which co-operate with the pliable side wall to open and close the bucket, the free end connectors comprising a means to rotatably connect the free ends of the mechanical swing arms in pairs.

19. A bucket as claimed in claim 16, wherein the Rim Opening Device has a lifting cord attached to the free end connector, when tension is applied there to the mechanical wishbones transitions from a closed vertical plane to a horizontal plane concentrically in co-operation with the pliable side wall to open the bucket.

20. A bucket as claimed in claim 19, wherein a first flexible tension links, a plurality of suspension lines co-operates with the Rim Opening Device lifting cords to lift the Rim Opening Device into the deployed horizontal position while not placing bucket weight on the Rim Opening Device or its lifting cords.

21. A bucket as claimed in claim 16, wherein each of the fixed end and the free end connectors have an angle of inclination which produces a concentric outward development of the Rim Opening Device when tension is applied to the lifting cords.

22. A bucket as claimed in claim 14, wherein the Rim Opening Device lifting cords have a means to hold open the bucket against the weighted wishbone arms which could collapse the bucket unexpectedly, when tension on the first flexible tension links is released.

23. A bucket as claimed in claim 16, wherein each of the free end connectors comprising; tracts for receiving the mechanical swing arms, a means for rotationally connecting the mechanical swing arms, a rotational limit stop to co-operate with and eliminate overcentering the mechanical swing arms above the horizontal lane, a means to locate the fixed end connectors adjacent the bucket's rim, a means to connect the lifting cord, and an angle of inclination are utilized to guide the mechanical swing arms concentric development of the Rim Opening Device's opening and closing of the bucket.

24. A bucket as claimed in claim 16, whereas the fixed end and the free end connectors have similar angles of inclination, size and shape, the free end connector is installed upside down as to the fixed end connector to facilitate upward and concentric development of the Rim Opening Device.

25. A bucket wherein the ballasting means to achieve a fast tipping action and submersion while filling is accomplished by a weight differential on opposite sides of the Rim Opening Device; the deployed plurality of interconnected mechanical wishbones, the fixed end connectors, the swing arms and the free end connectors have a higher specific gravity quotient or are heavier on one side of the Rim Opening Device than on the other creating the ballasted weight differential which promotes fast tipping and submersion.

26. A bucket as claimed in claim 25, wherein the tipping weight differential is dimensioned over about a 180 degree arc located adjacent the rim to achieve a torquing, quick tipping action and fast submersion during filling.

27. A bucket as claimed in claim 16, wherein the fixed end connectors are located adjacent the bucket rim, the mechanical Rim Opening Device is aerodynamically dimensioned; leeward, therein, below the rim, which co-operates with forward movement of the bucket during flight to produce a clean directional airflow above the bucket, not deflecting airflow therein.

28. A bucket as claimed in claim 14, wherein the deployed Rim Opening Device co-operates aerodynamically with its' dimensioned configuration within the centrally open top of the bucket to substantially reduce water loss during flight.

29. A bucket as claimed in claim 14, wherein the perimeter of the pliable rim is circumferentially and structurally supported by the weighted, deployed open, Rim Opening Device which co-operates with the tipping action to knife the leading edge underwater, facilitating rapid submersion and filling.

30. A pliable bucket as claimed in claim 14, wherein the deployed Rim Opening Device opens concentrically to define a structurally unrestricted centrally open round mouth which co-operates with the bucket body to receive general cargo.

31. A bucket as claimed in claim 14, wherein the deployed Rim Opening Device opens up concentrically to define a structurally unrestricted centrally open, essentially round mouth to co-operate with the bucket body to receive emergency evacuees, a flip down, pliable, emergency extractor jump seat and a seat belt harness co-operating to secure the evacuees for extraction from harms way.

32. A bucket as claimed in claim 14, wherein the tubular extensions resilient sealing lips have an abrasion resistant covering.

33. A bucket as claimed in claim 14, wherein the third flexible tension link purse lines are held in a straight line to the second flexible tension link to prevent kinking the tubular extension.

34. A bucket as claimed in claim 24, wherein the ballasting means to achieve rapid submersion during filling is structurally integral to the buckets mechanical opening device.

35. A bucket as claimed in claim 25, wherein the ballasting means to achieve a quick tipping action is arranged circumferentially and horizontally adjoined in union with, conterminous with, and contiguous with the buckets uppermost extremity, its rim, to maximize the ballasts Metacentric Height, thereby densely concentrating the gravitational tipping moment at the buckets upper rim.

36. A bucket claimed in claim 25, wherein the Metacentric Height of the ballast is consistent with the buckets maximum gravitational tipping moment.

37. A bucket as claimed in claim 14, wherein the valves lower seal, to the bucket's bottom, comprises of more than one independent resilient sealing collars, the lower one being permanently sealed to the inside of the bucket bottom and another being attached to the bottom of the valve, the two halves being removably fastened together, effecting a second seal, free of sealing compound.

38. A bucket as claimed in claims 14, wherein, when the valve is in the upright withdrawn position within the bucket, the resilient sealing lips are thinner above the grommetts through which the purse lines pass, than below them.

39. A bucket as claimed in claim 37, wherein the valves lower resilient sealing collars have a covering, such as fabric.

40. A bucket as claimed in claim 14, wherein the bucket has a secondary discharging means; a rigid, through bucket shell, bulkhead fitting, affixed to the bottom of a side panel, to which a sufficiently flexible, manually accessible hose, is affixed therefore.

41. A bucket as claimed in claim 40, wherein the distal end of the flexible discharge hose is open and has means to be variably connected vertically to the side of the said bucket.

42. A bucket as claimed in claim 40, wherein the distal, open end, of the secondary discharge hose can be variably affixed below the bucket rim to variably adjust the level of water in a bucket, a means of calibration being provided therefore.

43. A bucket as claimed in claim 15, wherein the length of the wishbone arms of the opening device are adjustable.

44. A bucket as claimed in claim 15, wherein the length of the structural arms adjustably co-operate with other structural members of the opening device, and the body of the bucket to apply circumferential tension at the bucket rim.

45. A bucket as claimed in claim 26, wherein centers of the circumferentially arranged tipping weights are in a vertically aligned plane when the bucket has been tipped horizontally, maximizing the downwardly force, to co-operate with the circumferentially tensioned rim of the bucket, to achieve quick submersion and filling.
